(19) United States
(12) Patent Application Publication
(10) Pub. No.: US 2006/0215215 A1
(43) Pub. Date: Sep. 28, 2006

(54) System and method for printer-based syndication

(76) Inventor: O.R. Senthil Kumaran, Jeevan Bhima Nagar (IN)

Correspondence Address: HAMILTON & TERRILE, LLP, P.O. BOX 203518, AUSTIN, TX, 78720, US

(21) Appl. No.: 11/087,966

(22) Filed: Mar. 23, 2005

(51) Int. Cl. G06F 3/12

(52) U.S. Cl. 358/1.15

(57) ABSTRACT

A printer integrates an aggregation module that autonomously retrieves syndication information from syndication network locations through a network for printing. Syndication information formatted in a syndication format having schema headers, such as RSS, is retrieved according to retrieval factors input by a user to the printer, such as at periodic intervals or at update indications received from the syndication network locations. The aggregation module retrieves syndication information associated with schema headers from the syndication network location to provide content to a print page as the page is formatted. A menu at the printer accepts user inputs of desired syndication information and retrieval factors for complete autonomy of the printer in the printing of syndication information to a print medium.

### BACKGROUND OF THE INVENTION

1. Field of the Invention

The present invention relates in general to the field of information handling system printers, and more particularly to a system and method for printer-based syndication of information.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with each other and peripherals through networks to communicate, print or otherwise process information. For instance, printers are often interfaced with a network to support printing of information from plural information handling systems, such as documents and photographs. The printer typically communicates with the network through an internal network interface card or through a conventional printer interface to a supporting information handling system that manages network communication. Generally, the information handling system requesting a print formats the information with an application and communicates the formatted information to the printer. The printer typically lacks intelligence for processing of information other than placing marks where indicated by the formatted information and performing basic maintenance functions.

As information handling systems have proliferated, businesses and individuals have come to increasingly rely on information handling systems to disseminate information. As an example, individuals often obtain news primarily through Internet sources. In some instances, individuals have replaced physical delivery of periodicals and newspapers with electronic versions delivered through the Internet. Various syndication technologies have developed to aid in the distribution of information, such as by electronic delivery of periodicals. Some examples are the Really Simple Syndication (RSS) and Atom standards for syndicated information that use Extensible Mark-up Language (XML) tags to format information by subject matter. An information handling system obtains the information through a network by applying RSS to selected desired syndicated information formatted with XML so that user can to display or print desired information. For instance, a user that subscribes to a newspaper electronic download service is able to identify sports and business sections for aggregation and display at the user's information handling system. Relevant news may be downloaded as desired, downloaded with a preset periodicity or downloaded when an update occurs at the news network site. Once the information handling system has downloaded and processed the RSS formatted information, a user may send the information to a printer to obtain a hard copy. Typically, printers as a standalone unit have no autonomous support for printing a regularly updating resource.

### SUMMARY OF THE INVENTION

Therefore a need has arisen for a system and method which autonomously prints information at a printer from a regularly updating resource.

In accordance with the present invention, a system and method are provided which substantially reduce the disadvantages and problems associated with previous methods and systems for printing information from a regularly updating syndication resource. A printer autonomously retrieves syndication information from a syndication network location according to predetermined retrieval factors, automatically parses the content and automatically prints the syndication information for presentation to a user on a print medium.

More specifically, a printer interfaces with one or more syndication network locations that provide syndication information in a syndication format, such as the RSS or Atom formats, having information parsed with XML schema headers. A menu module accepts user inputs for selection of syndication information to retrieve and factors to retrieve the information, such as periodic intervals or upon an update notification from a syndication network location. An aggregation module collects the syndication information by reference to the headers and formats the syndication information for printing to a print medium. A print module prints the syndication information with the content selected by the user at the menu module. Printing of syndication information is performed autonomously without the aid of an information handling system to aggregate and format the syndication information.

The present invention provides a number of important technical advantages. One example of an important technical advantage is that a standalone printer autonomously prints information provided from a regularly updated network resource. Aggregation of syndicated information from a syndication format to a desired print layout prints desired information without external support from an information handling system. A hardcopy of updated information is generated at the printer at regular intervals or as updates become available for the immediate attention of a user. For instance, aggregation of desired news content, such as sports and business, allows the user to focus on information of interest as the content becomes available. As another example, proof readers have the most recent updates possible printed as they become available without delays introduced by interaction with an information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for autonomous retrieval and printing of syndication information by a printer; and

FIG. 2 depicts a flow diagram of a process for autonomous retrieval and printing of syndication information by a printer.

### DETAILED DESCRIPTION

Autonomous output of printed content retrieved from a syndication network location at a standalone printer simplifies distribution of syndicated information though the integration of aggregation of syndication information in the printer rather than through a separate information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

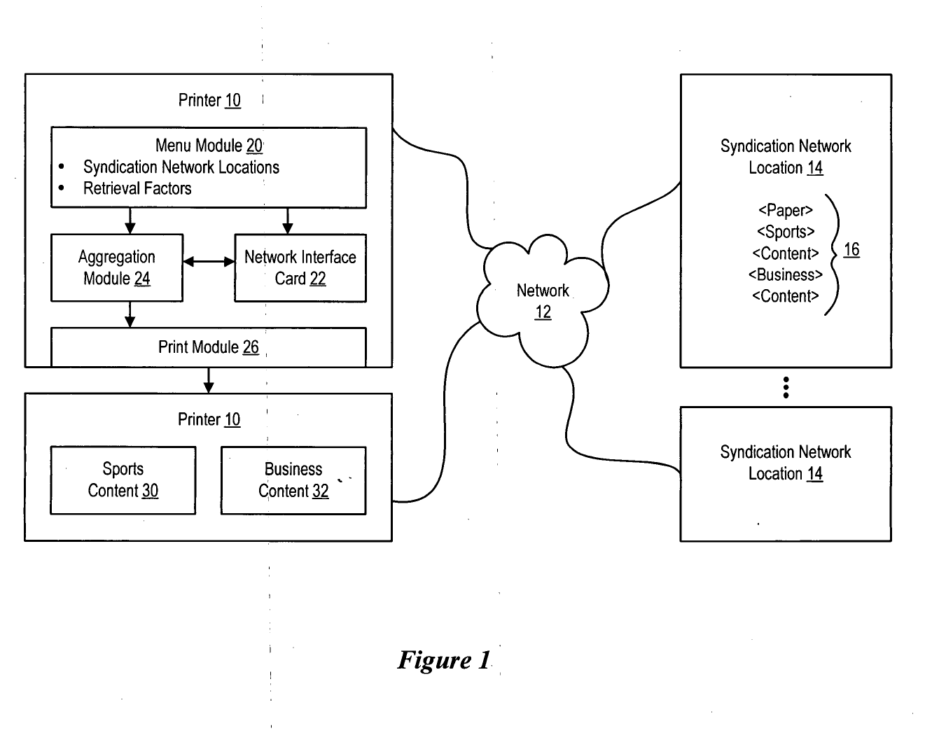

Referring now to FIG. 1, a block diagram depicts a system for autonomous retrieval and printing of syndication information by a printer. A printer 10 interfaces through a network 12, such as the Internet, with plural syndication network locations, such as server information handling systems that store syndicated information in a syndication format. As an example, syndication network location 14 provides an electronic newspaper subscription in the RSS XML format. The syndicated information is organized according to a standardized schema that divides the information by subject matter with headings, such as sports or business. Standardized syndication formats are readable by information handling systems 18 interfaced with network 12. Syndicated content is communicated to the information handling systems 18 by reference to the XML headings and aggregated for presentation to a user at the information handling systems 18.

Printer 10 acts autonomously to retrieve and print syndicated information without the aid or intervention of an information handling system 18 for aggregation of the syndicated information. A menu module 20 initiates communication of printer 10 with desired syndication network locations 14 through a network interface card 22 based on user input retrieval factors. A user inputs at menu module 20 the addresses of selected network locations and schema headers at the selected network locations that the user desires to have printed. The user associates at menu module 20 one or more retrieval factors that determine when printer 10 should retrieve and print the associated syndication information. For instance, retrieval of desired syndication information is initiated at regular periodic intervals, such as the time each day at which the paper is published. As another example, retrieval of desired syndication information is initiated when an update indication is received from a syndication network location 14, such as at the release of a news bulletin.

On initiation of retrieval of syndication information by menu module 20, an aggregation module 24 collects the desired syndication information and formats the collected content for printing. Information is aggregated by reference to desired XML schema headers to call content from the syndication network location at the formatting of the printout so that aggregated information need not be stored in the printer for formatting. The syndication information formatted for printing is provided to a print module 26 for transfer to a print medium 28. For instance, print module 26 is a laser or ink jet printer that prints to paper. The syndication information is aggregated into formatted content according to the parameters provided in XML RSS from the syndication network location 14. As one example, a user who inputs syndication network locations for sports content 30 and business content 32 will automatically have pages with that content printed autonomously by printer 10 according to the retrieval factors associated with the content.

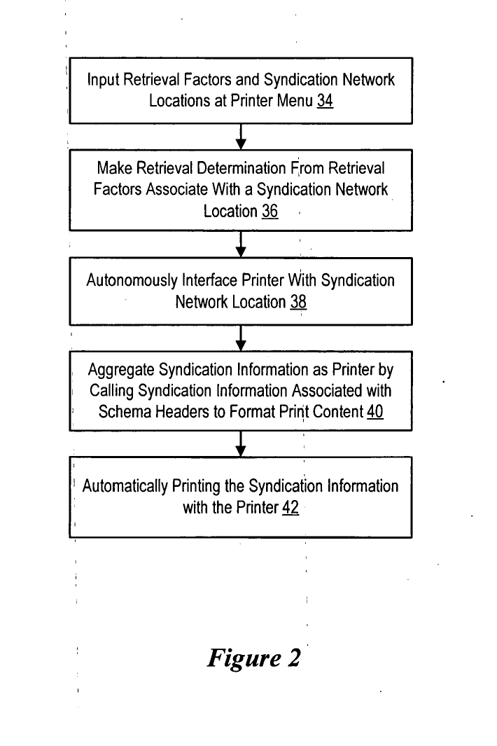

Referring now to FIG. 2, a flow diagram depicts a process for autonomous retrieval and printing of syndication information by a printer. The process begins at step 34 with the input of retrieval factors and syndication network locations at the printer menu. The content may be specified by a network location itself or by schema headers that organize content within a network location. At step 36, the printer makes an autonomous determination from predetermined retrieval factors associated with a syndication network location that syndication information retrieval should be initiated. At step 38, the printer autonomously interfaces with the syndication network location to retrieve the syndication information. At step 40, the syndication information is aggregated within the printer from the XML format of the syndication network location by calling information associated with desired schema headers and formatting the information in a print format. At step 40, the syndication information is automatically and autonomously printed at the printer for presentation to a user.

Although the present invention has been described in detail, it should be understood that various changes, substitutions and alterations can be made hereto without departing from the spirit and scope of the invention as defined by the appended claims.

What is claimed is:

1. A system for printing syndicated information from a syndication format, the system comprising:
plural syndication network locations, each syndication network location having syndicated information in the syndication format;
a printer operable to interface with the plural syndication network locations and to print information on a physical medium; and
an aggregation module integrated with the printer, the aggregation module operable to interface with one or more of the plural syndication network locations, to retrieve syndicated information, and to transfer the syndicated information from the syndication format to a print format for printing on the physical medium.

2. The system of claim 1 wherein the syndication format comprises an XML format having a schema with one or more tags and wherein the aggregation module is further operable to call the syndication information from the network location with the tags to prepare the print format.

3. The system of claim 2 wherein the XML format further comprises RSS.

4. The system of claim 1 wherein the aggregation module is further operable to retrieve predetermined syndication information at predetermined periods.

5. The system of claim 1 wherein the aggregation module is further operable to retrieve predetermined syndication information at predetermined updates of the syndication information of one or more network locations.

6. The system of claim 1 further comprising a menu module integrated with the printer and interfaced with the aggregation module, the menu module operable to accept user inputs of one or more syndication network locations.

7. The system of claim 6 wherein the menu module is further operable to accept user inputs of selected syndication information for retrieval from the syndication network locations.

8. The system of claim 7 wherein the menu module is further operable to accept user inputs of one or more factors for initiating retrieval of the syndication information.

9. A method for printing syndication information, the method comprising:
autonomously applying one or more factors at a printer to initiate retrieval of syndication information;
interfacing with the printer to a network to communicate with a syndication network location determined by the printer;
aggregating syndication information at the printer to format a page of printed content having the syndication information; and
automatically printing the page.

10. The method of claim 9 wherein aggregating syndication information further comprises:
determining syndication information schema headers associated with desired portions of the syndication information; and
retrieving content from the syndication network location with the schema headers to populate the page.

11. The method of claim 10 wherein the syndication information schema headers comprise RSS schema headers.

12. The method of claim 9 further comprising:
inputting at the printer one or more syndication network locations associated with desired syndication information; and
inputting at the printer one or more factors associated with each input syndication network location, the factors associated with an indication to retrieve syndication information from the associated syndication network location.

13. The method of claim 12 wherein the factors comprise a periodic time interval to retrieve the information.

14. The method of claim 12 wherein the factors comprise an update indication from the associated syndication network location.

15. An information handling system printer comprising:
a print module operable to print information on a print medium;
a network interface operable to communicate with network locations; and
an aggregation module interfaced with the print module and the network interface, the aggregation module operable to retrieve syndication information from a syndication network location and format the syndication information for printing by the print module.

16. The information handling system printer of claim 15 wherein the print module comprises a laser print module.

17. The information handling system printer of claim 15 wherein the print module comprise an ink jet print module.

18. The information handling system printer of claim 15 further comprising a menu module interfaced with the aggregation module and operable to accept user inputs that identify one or more syndication network locations and one or more retrieval factors associated with each syndication network locations, the network interface further operable to autonomously initiate retrieval from the syndication network locations according to the associated retrieval factors.

19. The information handling system printer of claim 18 wherein the retrieval factors comprise a periodic time interval.

20. The information handling system printer of claim 18 wherein the retrieval factors comprise an update indication from the associated syndication network location.
